(19) United States
(12) Patent Application Publication
(10) Pub. No.: US 2013/0200870 A1
(43) Pub. Date: Aug. 8, 2013

(54) LOW-DROPOUT VOLTAGE REGULATOR HAVING FAST TRANSIENT RESPONSE TO SUDDEN LOAD CHANGE

(71) Applicant: Kishan Pradhan, Bangalore (IN)

(72) Inventor: Kishan Pradhan, Bangalore (IN)

(21) Appl. No.: 13/366,537

(22) Filed: Feb. 6, 2012

(51) Int. Cl. G05F 1/10

(52) U.S. Cl. 323/283

(57) ABSTRACT

An apparatus comprising a regulator and a control circuit. The regulator may be configured to generate a regulated voltage in response to (i) a reference input signal, (ii) a pull down signal and (iii) a control signal. The control circuit may be configured to generate the control signal in response to a digital complement of the pull down signal. The regulator and the control circuit have a common supply voltage and ground. The regulator may comprise a pass through device and a protection device. The protection device may respond to the control signal to limit a load voltage that passes through the pass through device.

### FIELD OF THE INVENTION

The present invention relates to voltage regulators generally and, more particularly, to a method and/or apparatus for implementing a low-dropout voltage regulator having fast transient response to sudden load change.

### BACKGROUND OF THE INVENTION

Conventional core devices have the advantage of higher Gm/Cgs ratio compared to input/output (I/O) devices. Core devices can achieve higher speeds than I/O devices. Core devices also track the process corner of the block to which the core is supplying power, since both are implemented using similar devices. In the fast corner the block to which the regulator supplies power uses the most power. A regulator pass field effect transistor (FET) is also in the same fast corner, and can provide maximum current. Using core devices in an LDO exposes the core devices to higher voltage and/or stress. Such an application imposes serious concerns and/or reliability issues.

It would be desirable to implement a low-dropout voltage regulator having fast transient response to sudden load change.

It would also be desirable to implement a voltage protection circuit to overcome reliability issues of core devices.

### SUMMARY OF THE INVENTION

The present invention concerns an apparatus comprising a regulator and a control circuit. The regulator may be configured to generate a regulated voltage in response to (i) a reference input signal, (ii) a pull down signal and (iii) a control signal. The control circuit may be configured to generate the control signal in response to a digital complement of the pull down signal. The regulator and the control circuit have a common supply voltage and ground. The regulator may comprise a pass through device and a protection device. The protection device may respond to the control signal to limit a load voltage that passes through the pass through device.

The objects, features and advantages of the present invention include providing a voltage regulator that may (i) have fast transient response times, (ii) respond to sudden load changes, (iii) be cost effective to implement, (iv) provide a series core transistor, and/or (v) comprise a pass through device and a protection device.

### BRIEF DESCRIPTION OF THE DRAWINGS

These and other objects, features and advantages of the present invention will be apparent from the following detailed description and the appended claims and drawings in which:

FIG. 1 is a block diagram of an embodiment of the present invention;

FIG. 2 is a circuit diagram of an embodiment of the present invention;

FIG. 3 is a more detailed diagram of the circuit of FIG. 1;

FIG. 4a-c are graphs illustrating transient responses of the present invention versus conventional approaches;

FIG. 5 is a diagram of an alternate implementation of the control circuit; and

FIG. 6 is a diagram of an alternate implementation of the circuit of FIG. 1.

### DETAILED DESCRIPTION OF THE PREFERRED EMBODIMENTS

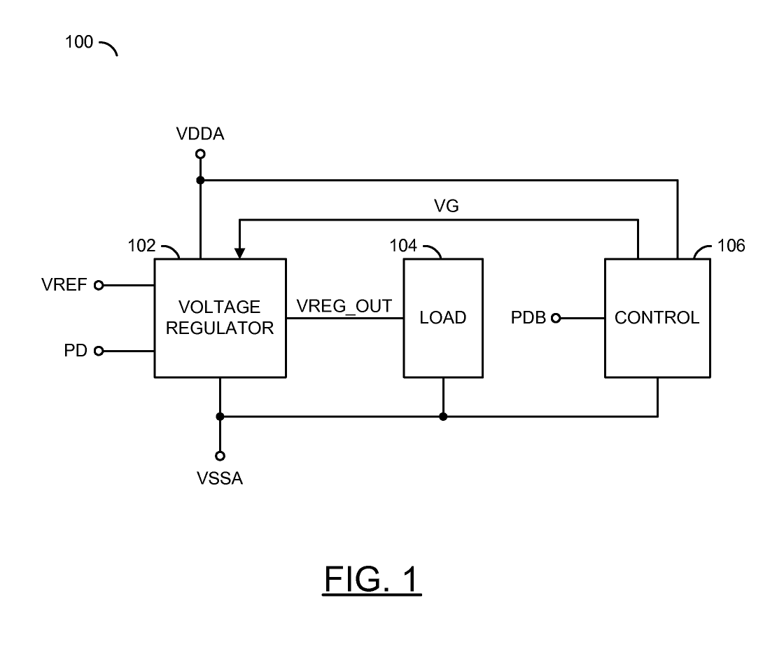

Referring to FIG. 1, a block diagram of a circuit 100 is shown in accordance with a preferred embodiment of the present invention. The circuit 100 generally comprises a block (or circuit) 102, a block (or circuit) 104 and a block (or circuit) 106. The circuit 102 may be implemented as a voltage regulator. The circuit 104 may be implemented as a load. The circuit 106 may be implemented as a control circuit. In one example, the circuit 102 and/or the circuit 106 may be implemented on an integrated circuit (IC). The load circuit 104 may be implemented off-chip (e.g., separately from the IC that may implement the circuit 102 and/or the circuit 106). A signal VDDA may be implemented as a supply voltage. A signal VSSA may be implemented as a ground voltage.

The voltage regulator circuit 102 may generate a signal (e.g., VREG_OUT) in response to a signal (e.g., VG), a signal (e.g., VREF), and a signal (e.g., PD). The load circuit 104 may receive the signal. VREG_OUT. The control circuit 106 may be configured to generate the signal VG in response to a signal (e.g., PDB). The circuit 102, the circuit 104 and/or the circuit 106 may receive the supply voltage VDDA. Similarly, the circuit 102, the circuit 104 and/or the circuit 106 may be connected to the ground voltage VSSA.

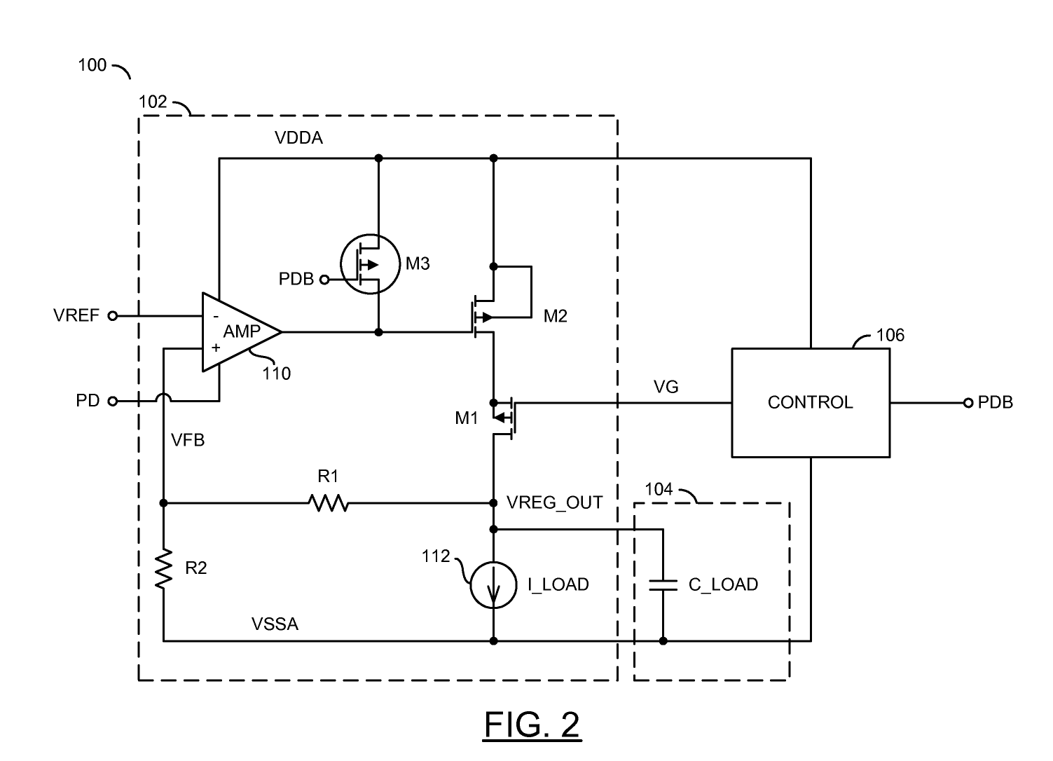

Referring to FIG. 2, a more detailed diagram of the circuit 100 is shown. The circuit 102 generally comprises a resistor R1, a resistor R2, a transistor (or device) M1, a transistor M2, a transistor M3, a block (or circuit) 110, and a block (or circuit) 112. The circuit 110 may be implemented as an amplifier. The circuit 112 may be implemented as a current load (e.g., I_LOAD).

The circuit 100 may provide an improved LDO voltage regulator incorporating a core pass field effect transistor (FET) M2. The transistor (or device) M2 may tolerate, for example, 1V across a source and a drain of a device in a typical 28 nm technology. The circuit 102 may be implemented to protect the transistor M2 from a potential over voltage. The transistor M1 may be implemented as a core pass FET that may tolerate, for example, 1.0V in typically 28 nm technology. The particular voltages of the transistor M1 and/or the transistor M2 may tolerate and be varied to meet the design criteria of a particular implementation. In general, the transistor M1 may be implemented to tolerate a voltage approximately equal to a voltage across the transistor M2. By tolerating approximately equal voltages, the transistor M1 protects the transistor M2 from potentially damaging voltages. The circuit 100 may be implemented to provide improved transient response to sudden load current changes.

The device M1 may be implemented using core processing techniques such as a PMOS process. The device M1 may be implemented in series with the device M2. In one example, the device M2 may be implemented as a core PASS FET. The gate voltage of the device M1 may be controlled by the circuit 108. The circuit 106 may have different operating states than the voltage regulator 102.

The protection device M1 may act as an ON switch during normal regulation operation of the regulator circuit 102. During a power down mode, a gate of the protection device M1 may be kept at a reduced voltage (e.g., half of the input supply voltage VDDA). The voltage across the PASS FET device M2 may be less than the supply rail voltage VDDA.

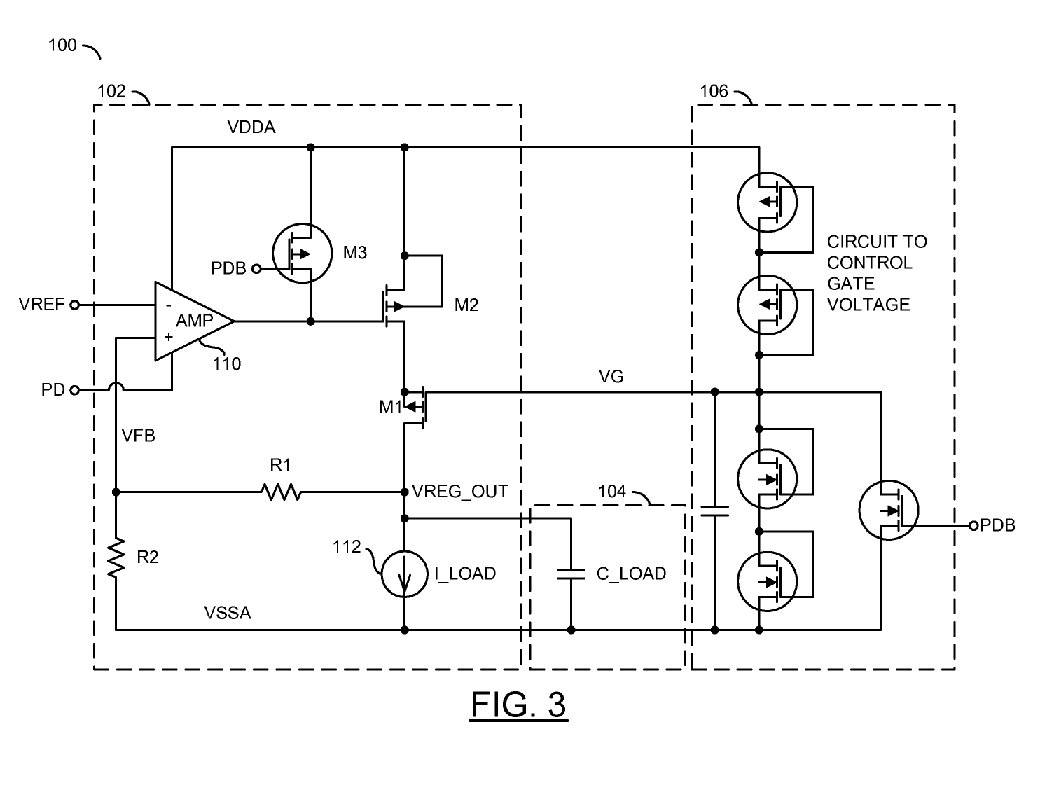

Referring to FIG. 3, a diagram showing a more detailed diagram of the control circuit 106 is shown. The transistor M2 may be implemented within the regulator 102 as a core pass device. The transistor M1 may be implemented as a protection device.

During normal regulator operation (e.g., PD=0; PDB=1), the protection device M1 may be ON with minimum resistance to reduce power loss. The gate voltage (e.g., VG) is pulled down to ground by the gate control circuit 106.

During power down mode, the voltage VREG_OUT may discharge to ground. Without the transistor M1, the voltage across the transistor M2 would increase to the supply voltage VDDA (e.g., 1.8V for 28 nm technology) which is greater than the stress limit (1V for 28 nm technology). Such a condition may impose reliability issues. Such a condition may be avoided by implementing the transistor M1 and having a gate controlled by the control circuit 106. The gate voltage VG of the transistor M1 may be set near to VDDA/2 during power down (e.g., PD=1; PDB=0). As a result, the voltage drop across the transistor M1 and the transistor M2 is approximately VDDA/2. With such an implementation, the supply voltage VDDA may be twice the stress limit of core devices.

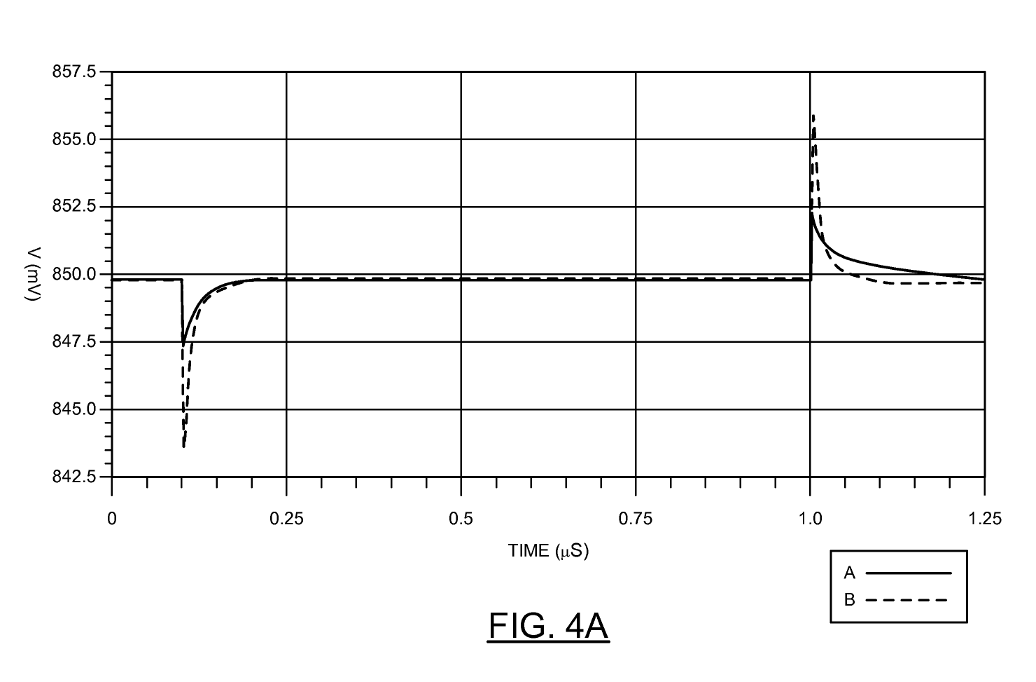

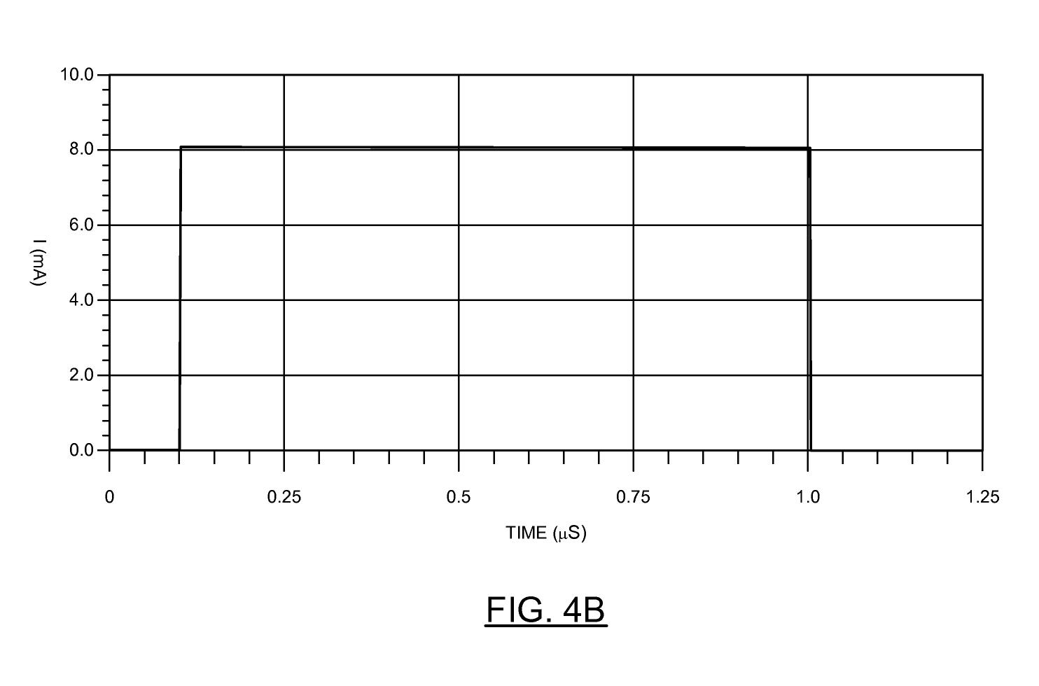

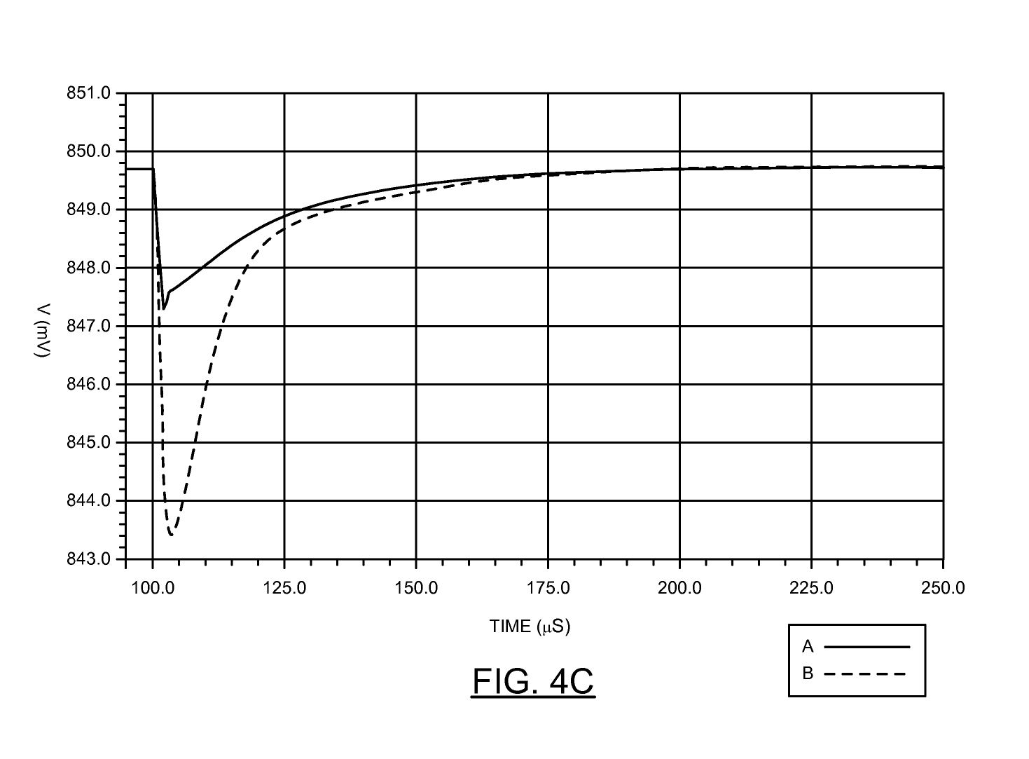

FIG. 4 shows the typical transient for an LDO voltage regulator incorporating a core device and its protection circuit in accordance with the present invention (trace ‘a’) in comparison with conventional LDO voltage regulator (trace ‘b’). The X-axis is shown implemented in microseconds. The Y-axis is shown implemented in mA. FIG. 4A shows the undershoot and the overshoot due to sudden change in load current. FIG. 4B shows the fast change of load current. FIG. 4C is a zoomed-in view of the FIG. 4A for the undershoot part.

The circuit 100, when compared to previous approaches under similarly biased conditions, may provide (i) improved transient response (e.g., 66% improvement in ripple in 28 nm technology), (ii) improvement in bandwidth (e.g., 4 times for 28 nm technology), (iii) track process corners, and/or (iv) reduction in PASS FET area (5 times for 28 nm technology).

The LDO voltage regulator circuit 100 may experience two states—a power down toggle and an initial power-up sequence. Simulations may be run to validate the protection of the core pass FET in the above two states. Such over-voltage simulations may test reliability and/or validate the devices M1 and/or M2 in both states.

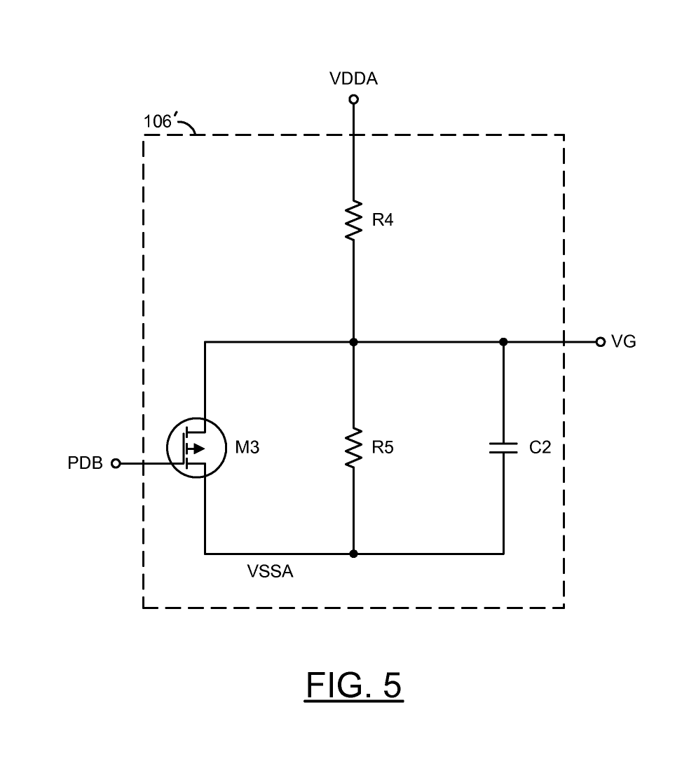

Referring to FIG. 5, a diagram of an alternate implementation of the control circuit 106′ is shown. The circuit 106′ generally comprises the transistor M3, a device (e.g., R4), a device (e.g., R5), and a device (e.g., C2). The device R4 and the device R5 may be implemented as resistors. The device C2 may be implemented as a capacitor.

During normal regulator operation (e.g., PD=low; PDb=high) the protection device M1 is normally ON, with minimum resistance to reduce power loss. The gate voltage Vg is normally pulled down to ground by the gate control circuit 106.

During power down mode, the signal VREG_OUT may discharge to ground. In an implementation without the transistor M1, the voltage across the transistor M2 is normally VDDA (e.g., 1.8V for a 28 nm technology), which is greater than a stress limit (e.g., 1V for 28 nm technology) and may impose a reliability issue. With the help of the transistor M1, and a corresponding controlled gate (through the circuit 106) such a stress may be avoided. The gate voltage Vg may be set near to VDDA/2 during power down (e.g., PD=high; PDb=low). As a result, the voltage drop across the transistor M1 and the transistor M2 may be approximately VDDA/2. The voltage VDDA may be twice the stress limit of core devices.

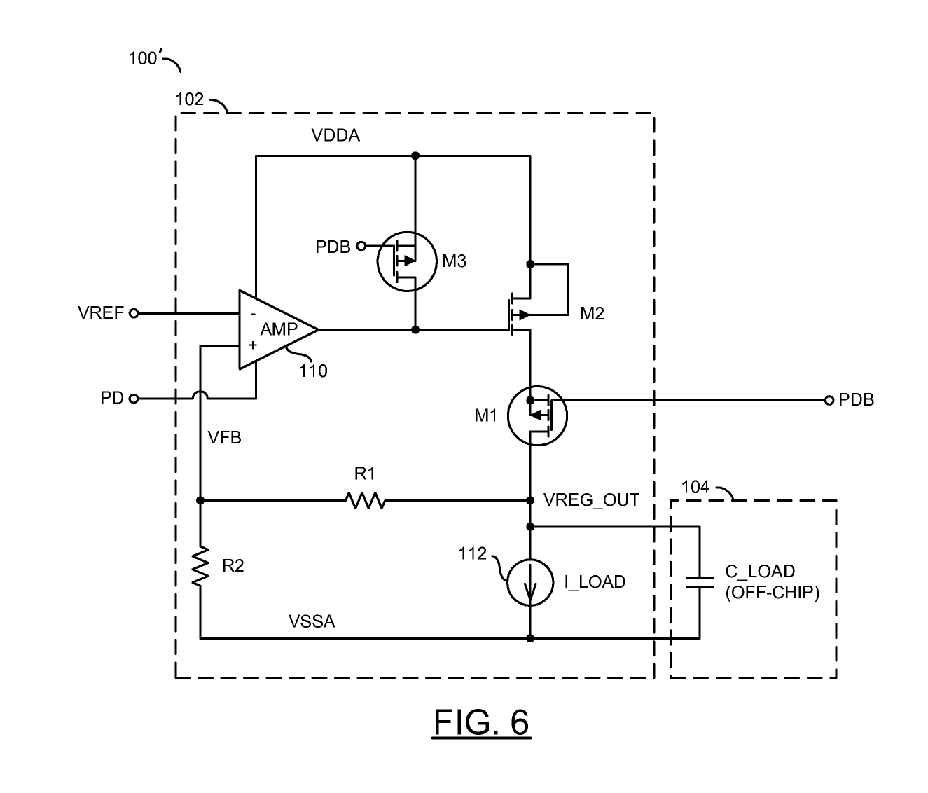

Referring to FIG. 6, a circuit 100′ shows an alternate implementation. The circuit 100′ is shown implemented without the control circuit 106. In such an implementation, the signal PDB may be presented directly to the transistor M1. The transistor M1 may be implemented as an IO device (e.g., an IO device is generally indicated with a round envelope).

During normal regulator operation (e.g., PD=low; PDb=high) the protection device M1 is normally ON, with minimum resistance to reduce power loss. During power down mode, the signal VREG_OUT may discharge to ground. If there was no transistor M1, then voltage across the transistor M2 is VDDA (e.g., 1.8V for 28 nm Technology) which is greater than its stress limit (e.g., 1V for 28 nm technology) and may impose reliability issues. With the help of the transistor M1 and the controlled gate, it is possible to avoid this issue. The gate of the transistor M1 may be set to VDDA during power down (e.g., PD=high; PDb=low). As a result, the voltage drop across the transistor M1 is VDDA and may be kept within specifications. The voltage across the transistor M2 is 0, and hence has no stress issues.

In the implementation when the transistor M1 is an IO device, the size of the transistor M1 is normally increased to have the same resistance as the core device(s). The circuit 106′ may provide a large resistive area to reduce standby power. The circuit 106′ may provide a high settling time of Vg due to large resistive element.

While the invention has been particularly shown and described with reference to the preferred embodiments thereof, it will be understood by those skilled in the art that various changes in form and details may be made without departing from the scope of the invention.

1. An apparatus comprising:
a regulator configured to generate a regulated voltage in response to (i) a reference input signal, (ii) a pull down signal and (iii) a control signal; and
a control circuit configured to generate said control signal in response to a digital complement of said pull down signal, wherein said regulator and said control circuit have a common supply voltage and ground.

2. The apparatus according to claim 1, wherein said regulator comprises a pass through device and a protection device, wherein said protection device responds to said control signal to limit a load voltage that passes through said pass through device.

3. The apparatus according to claim 2, wherein said pass through device and said protection device are implemented in series.

4. The apparatus according to claim 3, wherein said pass device operates at a core voltage and said protection device operates at an I/O voltage.

5. The apparatus according to claim 4, wherein said core voltage is implemented as 1.0 volts and said I/O voltage is implemented as 1.8 volts.

6. The apparatus according to claim 2, wherein the pass device is configured to operate at half of a supply voltage.

7. The apparatus according to claim 2, wherein said supply voltage is approximately twice a stress limit of said pass device.

8. The apparatus according to claim 2, wherein said regulator and said control circuit are implemented on an Integrated Circuit (IC).

9. An apparatus comprising:
means for generating a regulated voltage in response to (i) a reference input signal, (ii) a pull down signal and (iii) a control signal; and
means for generating said control signal in response to a digital complement of said pull down signal, wherein said means for generating said regulated voltage and said means for generating said control signal have a common supply voltage and ground.

10. A method for regulating a voltage having a fast transient response, comprising the steps of:
(A) generating a regulated voltage in response to (i) a reference input signal, (ii) a pull down signal and (iii) a control signal; and
(B) generating said control signal in response to a digital complement of said pull down signal, wherein step (A) and step (B) have a common supply voltage and ground.

11. The method according to claim 10, wherein said method regulates said voltage having said fast transient response to a sudden load change.

12. The method according to claim 10, wherein step (A) implements a pass through device and a protection device, wherein said protection device responds to said control signal to limit a load voltage that passes through said pass through device.

13. The method according to claim 12, wherein said pass through device and said protection device are implemented in series.

14. The method according to claim 12, wherein said pass device operates at a core voltage and said protection device operates at an I/O voltage.

15. The method according to claim 14, wherein said core voltage is implemented as 1.0 volts and said I/O voltage is implemented as 1.8 volts.

16. The method according to claim 12, wherein the pass device is configured to operate at half of a supply voltage.

17. The method according to claim 12, wherein said supply voltage is approximately twice a stress limit of said pass device.
